(19) United States
(12) Patent Application Publication
(10) Pub. No.: US 2007/0224493 A1
(43) Pub. Date: Sep. 27, 2007

(54) Non-aqueous electrolyte battery

(75) Inventors: Hayato Higuchi, Osaka (JP); Toshihiro Abe, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/723,915

(22) Filed: Mar. 22, 2007

(30) Foreign Application Priority Data
Mar. 24, 2006 (JP) P2006-082374

(51) Int. Cl. H01M 2/18; H01M 2/16

(52) U.S. Cl. 429/130; 429/94; 429/254

(57) ABSTRACT

A non-aqueous electrolyte battery having an wound electrode body including a positive electrode having a layer of a positive electrode active material formed on a current collector, a negative electrode having a layer of a negative electrode active material formed on a current collector and a separator interposed between the positive electrode and the negative electrode, and a non-aqueous electrolyte, where the positive electrode has an exposed portion having no layer of the positive electrode active material at least at one of a winding-start edge and a winding-finish edge of the positive electrode so as to provide a lead member connected to an external terminal, an insulating layer of plural resins is formed on the exposed portion of the current collector of the positive electrode in a part in which the exposed portion of the current collector of the positive electrode faces that of the negative electrode via the separator, and the winding-start edge or the winding-finish edge of the positive electrode having no lead member has no exposed portion of the current collector.

### FIELD OF THE INVENTION

The present invention relates a non-aqueous electrolyte battery. In particular, the present invention relates to a non-aqueous electrolyte battery which is suitably used as an electric source of a portable electronic device, a battery vehicle, a load leveling system, etc.

### BACKGROUND ART

Lithium ion batteries, one example of non-aqueous electrolyte batteries, are widely used as the electric source of portable electric devices, for example, portable telephones, notebook-sized personal computers, etc., since they have a high energy density. Besides, the importance of secondary batteries which can be repeatedly charged has been increased out of consideration for environmental concerns. Thus, apart from the portable electric devices, the application of the lithium ion batteries to automobiles, electric wheeled chairs, domestic or commercial electricity storage systems, etc. is discussed.

An existing lithium ion battery is produced by winding a positive electrode, a negative electrode and a separator in the form of a cylinder or a flat body to form a spirally wound electrode body, inserting the electrode body in a metal can made of, for example, aluminum or stainless steel, pouring an electrolyte solution in the can, and sealing the can. With regard to the positive and negative electrode sheets constituting the spirally wound electrode body, the length and width of the negative electrode sheet are made larger than those of the positive electrode sheet to prevent the deposition of lithium liberated from the positive electrode during charging, and the width of the separator is made large to surely insulate the electrode sheets.

A separator for a lithium ion battery usually has a very small thickness of 20 μm or less to decrease the thickness of the battery and to increase a capacity of the battery. If the separator is damaged or it is moved from the right position when the battery is shocked, the positive and negative electrodes may be brought into contact with each other to cause short circuiting.

In the case of short circuiting, when a negative electrode and a layer containing a positive electrode active material are brought into contact each other, the amount of heat generated is small since the electric resistance of the layer containing a positive electrode active material is relatively large and thus a short-circuit current is small. However, when the negative electrode and the exposed portion of the current collector of the positive electrode are brought into contact each other, the amount of heat generated is large since the electric resistance of the current collector is small and thus the short-circuit current is large. In particular, the contact between the exposed portion of the current collector of the negative electrode and that of the current collector of the positive electrode is dangerous since it is the contact of metal parts so that the short-circuit current becomes very large. Accordingly, the current collector of the positive electrode preferably has no exposed portion.

However, in the case of a lithium ion battery, the exposed portion of the current collector having no layer of the positive electrode active material should be formed at either a winding-start edge or a winding-finish edge of the current collector so as to provide a lead member which is connected to an external terminal. Therefore, the exposed portion of the current collector of the positive electrode should face the negative electrode. If they are short circuited, the amount of heat generated is large so that the potential of a risk such as ignition and explosion increases.

To solve the above problems, it is proposed to adhere an insulating tape to a part where the exposed portion of the positive electrode faces the negative electrode. The thickness of the insulating tape is usually at least 30 μm from the viewpoint of costs and handling easiness, and is larger than the thickness of the separator used in the lithium ion battery. Therefore, the thickness of the insulating tape increases the total thickness of the battery, and may have any adverse influence on the designing of a battery having a smaller thickness.

Apart from the use of an insulating tape, the following measures are proposed: a solution of polyvinylidene fluoride (PVdF) in N-methyl-2-pyrrolidone is coated on the current collector of a positive electrode to form a layer of PVdF which is used as an insulating layer, or an insulating film comprising a power having heat resistance at a temperature of 500° C. or higher which is bound with a binder resin is formed on the exposed portion of a current collector (JP-A-2004-259625 and JP-A-2004-63343).

However, when the insulating layer is made of a single resin having a high crystallinity such as PVdF, the resin molecules shrink during the evaporation of the solvent and thus the film of PVdF shrinks. In addition, when the insulating layer has a low adhesion property to a current collector foil, the resin film is removed from the current collector foil. When the hard powder particles having a melting point of 500° C. or higher is used, the shrinkage of the coated film may be prevented to some extent, but the resin film becomes brittle. Therefore, the resin film may be peeled off from the current collector foil. Such a problem remarkably arises at the edge of the current collector foil, and the desired insulating effect is not attained.

### SUMMARY OF THE INVENTION

One object of the present invention is to provide a non-aqueous electrolyte battery which does not have any unnecessary exposed portion of a current collector of a positive electrode, and has a robust insulating layer which is formed at a part where the exposed portion of the current collector of the positive electrode faces a negative electrode through a separator, whereby an accident caused by heat generation is prevented even when short circuiting occurs.

Another object of the present invention is to provide a method for producing such a non-aqueous electrolyte battery.

Accordingly, the present invention provides a non-aqueous electrolyte battery comprising an wound electrode body which comprises a positive electrode having a layer of a positive electrode active material formed on a current collector, a negative electrode having a layer of a negative electrode active material formed on a current collector and a separator interposed between the positive electrode and the negative electrode, and a non-aqueous electrolyte, wherein the positive electrode has an exposed portion having no layer of the positive electrode active material at least at one of a winding-start edge and a winding-finish edge of the positive electrode so as to provide a lead member which is connected to an external terminal, an insulating layer comprising at least two resins is formed on the exposed portion of the current collector of the positive electrode in a part where the exposed portion of the current collector of the positive electrode faces the exposed portion of the current collector of the negative electrode through the separator, and the winding-start edge or the winding-finish edge of the positive electrode having no lead member has no exposed portion of the current collector.

### BRIEF DESCRIPTION OF THE DRAWINGS

FIG. 1 schematically shows a cross section of a positive electrode produced in Example 1 according to the present invention.

FIG. 2 schematically shows a wound electrode body in the vicinity of the periphery thereof, which is produced in Example 1 according to the present invention.

FIG. 3 is an electron micrograph of the surface of the insulating resin layer formed in Example 1 according to the present invention.

FIG. 4 shows the front and side views of a typical example of a rectangular battery.

FIG. 5 illustrates a method for performing a crush test of a battery employed in the Examples.

### DETAILED DESCRIPTION OF THE INVENTION

In order to prevent direct contact between an exposed portion of a current collector of a positive electrode and that of a negative electrode, the non-aqueous electrolyte battery of the present invention has such a structure that the positive electrode has no exposed portion of the current collector at its winding-start edge or winding-finish edge to which no lead member is provided, and the positive electrode has an insulating layer on the exposed portion of the current collector at its winding-start edge or winding-finish edge where a lead member is provided. The insulating layer is preferably designed not to be fractured or peeled off from the current collector even when the battery is dropped or shocked during use or the insulating layer rubs against something in the production process of the battery and also designed to keep its insulating function even when a force is exerted on the battery by, for example, pressing and to have stability against an electrolyte to prevent the dissolution thereof in the electrolyte or excessive swelling leading to the peeling-off of the insulating layer from the current collector. To leave no unnecessary exposed portion of the current collector of the positive electrode, an edge part of the positive electrode is cut out at a position having the positive electrode active material-containing layer to remove the exposed portion of the current collector of the positive electrode.

In order to improve the strength of the insulating resin layer against pressing, a resin used in the present invention is preferably a hard resin and has a large molecular weight and a high crystallinity to prevent fracture. Such a resin layer is generally formed by applying a solution prepared by dissolving a resin in a solvent to the exposed portion of the collector, and drying the solution applied. However, when the resin having a high crystallinity is used, the resin layer largely shrinks when the solution applied is dried to remove the solvent, and has low flexibility. Therefore, when the resin layer is formed to have a thickness of 5 μm or more to ensure insulation, the film strength of the resin layer is greater than the adhesive force of the resin layer to the current collector foil so that the resin layer is peeled off from the current collector.

In order to avoid the peeling-off of the insulating resin layer from the current collector, the insulating resin layer preferably comprises a mixture of two or more resins, since the use of the mixture of two or more resins makes it possible to alleviate the shrinkage of the resin insulating layer caused by the evaporation of the solvent in comparison with the use of a single resin. More preferably, one of the resins in the resin mixture is present in the form of a spherical, substantially spherical, cluster, fibrous, rod or crushed shape, and is uniformly distributed in other resin or one of the other resins in a sea-island structure. Such a sea-island structure of the resin mixture can enhance the effect of suppressing the shrinkage of the insulating resin layer and therefore to improve the adhesion of the insulating resin layer to a base material.

The size of the resin used to form the islands of the sea-island structure of the insulating layer is not particularly limited as long as its particle size is smaller than the thickness of the insulating layer. More specifically, the number average particle size of the resin is preferably from 0.1 to 50 μm, more preferably from 0.1 to 30 μm. The shape of the resin can be selected depending on the desired insulating strength of the insulating resin layer or the properties of a coating composition to be used for forming the insulating resin layer.

Preferred examples of the resins forming the insulating layer include polyethylene, polypropylene, an ethylene-propylene copolymer, an ethylene-vinyl acetate copolymer, polymethyl methacrylate, and an ethylene-methyl methacrylate copolymer, and derivatives thereof. Also, cross-linked products of these resins can be preferably used to improve the solvent resistance of the insulating layer.

It is not desirable for the insulating resin layer to be peeled off from the current collector in the battery. Therefore, the insulating resin layer is preferably insoluble in an electrolyte. To this end, PVdF or a derivative thereof is preferably used as one of the resins of the insulating layer. The insulating resin layer is likely to be peeled off from the current collector when it is excessively swelled with the electrolyte. However, when the insulating resin layer is swelled to some extent, the area of the insulating resin layer increases so that it becomes larger than the positive electrode in the widthwise direction of the positive electrode, that is, the positive electrode is covered with the insulating resin layer having a larger width than that of the positive electrode, thereby the insulating property is further improved.

The insulating resin layer should be formed at least in an area where the exposed portion of the current collector of the positive electrode faces that of the current collector of the negative electrode. Therefore, the insulating resin layer can be formed not only on the exposed portion of the current collector of the positive electrode facing the current collector of the negative electrode but also on either or both of the separator and the current collector of the negative electrode.

The thickness of the insulating resin layer is desirably as small as possible in view of the total thickness of the battery. When the thickness of the insulating resin layer is too small, the insulating resin layer has an insufficient insulating strength. Therefore, the thickness of the insulating layer is preferably from 5 to 30 μm, more preferably from 10 to 20 μm.

The insulating resin layer is preferably formed by the following method: a solvent in which at least one resin is dissolved but other resin cannot, is selected, and the resins are dissolved and dispersed in the solvent to prepare a slurry containing the particles of the resin which is not dissolved in the solvent. Then, the slurry is applied on a base material such as the current collector of the positive electrode or the separator (e.g., a polyolefin separator) with a die coater, a gravure coater, a reverse coater or a spray coater, and the slurry is dried to remove the solvent.

When the insulating resin layer is formed on the current collector of the positive electrode, preferably a part of the insulating resin layer overlaps the upper or lower surface of the layer containing the positive electrode active material to ensure insulation of an exposed portion of the current collector.

Hereinafter, other components of the non-aqueous electrolyte battery of the present invention will be explained. The non-aqueous electrolyte battery of the present invention includes a primary battery and a secondary battery, but the present invention will be explained by making reference to a secondary battery, which is the primary application of the present invention.

A positive electrode used in the present invention may be one used in conventional non-aqueous electrolyte batteries. Examples of an active material of the positive electrode include lithium-containing transition metal oxides represented by LiMO₂ wherein M is a transition metal, in particular, lithium cobalt oxides such as LiCoO₂, lithium nickel oxides such as LiNiO₂, lithium manganese oxides such as LiMn₂O₄, LiMnₓM₍₁₋ₓ₎O₂ obtained by substituting a part of Mn of LiMn₂O₄ with another element, Olivine type LiMPO₄, wherein M is Co, Ni, Mn or Fe, LiMn_{0.5}Ni_{0.5}O₂, and Li₍₁₊ₐ₎MnₓNi_{y}Co_{(1-x-y)}O₂ wherein −0.1<a<0.1, 0<x<0.5 and 0<y<0.5.

A positive electrode used in the present invention can be prepared by, for example, adding a binder such as polyvinylidene fluoride (PVdF) and a conventional conductive aid (e.g., carbonaceous materials such as carbon black) to the positive electrode active material to obtain a positive electrode mixture and applying the positive electrode mixture on at least one surface of a current collector.

Examples of the current collector of the positive electrode include a metal foil, perforated metal, metal mesh, or expanded metal of aluminum, titanium, or the like. Among them, an aluminum foil is preferably used. The thickness of the current collector of the positive electrode is preferably as small as possible from the viewpoint of increasing the energy density of the battery. However, when the thickness of the current collector of the positive electrode is too small, it may have lowered strength. Therefore, the thickness of the current collector of the positive electrode is preferably from 8 to 30 μm.

Usually, a lead member portion of the positive electrode is formed by leaving the exposed portion of the current collector without forming any positive electrode mixture layer on a part of the current collector when the positive electrode is produced. However, the lead member portion may not necessarily be formed integrally with the current collector, and it may be provided by connecting an aluminum foil or the like to the current collector after the production of the positive electrode.

A negative electrode used in the present invention may be one used in conventional non-aqueous electrolyte batteries. Examples of an active material of the negative electrode include carbonaceous materials capable of occluding and releasing lithium, such as graphite, pyrolytic carbon, cokes, glassy carbons, burned organic polymer compounds, mesocarbon microbeads (MCMB), and carbon fibers. These carbonaceous materials can be used singly or in combination of two or more of them. Further examples of the active material of the negative electrode include alloys of Si, Sn, Ge, Bi, Sb and/or In, compounds capable of charging and discharging at a low voltage close to metal lithium, such as lithium-containing nitrides and oxides, metal lithium, and an lithium-aluminum alloy.

The negative electrode used in the present invention may be produced by adding a binder such as PVdF and a conductive aid (e.g., carbonaceous materials such as carbon black) to a negative electrode active material to obtain a negative electrode mixture and applying the negative electrode mixture on at least one surface of a current collector. Alternatively, as the negative electrode, a foil made of one of the alloys described above or a lithium metal foil may be used singly or in the form of a laminate of such a foil and a current collector.

When the negative electrode includes a current collector, the current collector comprises a copper or nickel foil, perforated metal, metal mesh or expanded metal. Preferably, the current collector comprises a copper foil. The thickness of the current collector of the negative electrode is preferably 30 μm or less from the viewpoint of increasing the energy density of the battery, while it is preferably 5 μm or more from the viewpoint of handling properties and strength of the current collector.

As in the case of the lead member portion of the positive electrode, a lead member portion of the negative electrode is usually provided by the exposed portion of the current collector without forming any negative electrode mixture layer on a part of the current collector when the negative electrode is produced. However, the lead member portion may not necessarily be formed integrally with the current collector, and it may be provided by connecting an copper foil or the like to the current collector after the production of the negative electrode. When the negative electrode is produced using no negative electrode mixture, no lead member portion is necessary.

An electrolyte used in the present invention may be a solution of at least one lithium salt dissolved in an organic solvent or an organic solvent mixture. Examples of the lithium salt include LiClO₄, LiPF₆, LiBF₄, LiAsF₆, LiSbF₆, LiCF₃SO₃, LiCF₃CO₂, Li₂C₂F₄ (SO₃)₂, LiN(CF₃SO₂)₂, LiC(CF₃SO₂)₃, LiCₙF₂ₙ₊₁SO₃ (n≧2), and LiN(RfOSO₂)₂ wherein Rf is a fluoroalkyl group. Examples of the organic solvent include dimethyl carbonate, diethyl carbonate, methyl ethyl carbonate, methyl propionate, ethylene carbonate, propylene carbonate, butylene carbonate, γ-butyrolactone, ethylene glycol sulfite, 1,2-dimethoxyethane, 1,3-dioxolane, tetrahydrofuran, 2-methyltetrahydrofuran and diethyl ether. These solvent may be used singly or a mixture of two or more of them. The concentration of the lithium salt in the electrolyte is preferably from 0.5 to 1.5 mol/L, more preferably from 0.9 to 1.25 mol/L.

The non-aqueous electrolyte battery of the present invention can be in the form of a rectangular battery or a cylindrical battery comprising a metal can made of stainless steel, aluminum or the like as a casing material, or a soft-package battery using a metallized laminate film as a casing material.

The present invention will be described in more detail with reference to the following examples, which do not limit the scope of the present invention in any way.

### EXAMPLE 1

Production of Positive Electrode

Eighty-five (85) parts by weight of LiCoO₂ as a positive electrode active material, 10 parts by weight of acetylene black as a conductive assistant, and 5 parts by weight of PVdF as a binder were uniformly mixed with N-methyl-2-pyrrolidone (NMP) as a solvent to prepare a paste containing a positive electrode mixture. This paste was applied on both surfaces of a 15 μm thick aluminum foil as a current collector, so that the length of the active material applied onto the front surface was 280 mm and the length of the active material applied onto the back surface was 210 mm, and then dried to form positive electrode mixture layers on the current collector.

Then, the positive electrode mixture layers were calendered to adjust the total thickness of the current collector and the positive electrode mixture layers to 150 μm, and the current collector having the positive electrode mixture layers formed thereon was cut to form a positive electrode having a length of 302 mm and a width of 43 mm. An aluminum tab (width: 3 mm, thickness: 80 μm) as a lead member was ultrasonic-welded to an exposed portion of the aluminum foil of the positive electrode. Further, another end of the aluminum foil, to which the tab was not connected, was cut at a position on the positive electrode mixture layer 2 mm away from the edge of the positive electrode mixture layer to remove an unnecessary exposed portion of the aluminum foil, to obtain a positive electrode having a length of 300 mm, in which the active material applied onto the front surface was 278 mm long, the active material applied onto the back surface was 208 mm long, and the exposed portion of the front surface to which the tab was connected was 22 mm long.

Formation of Insulating Resin Layer

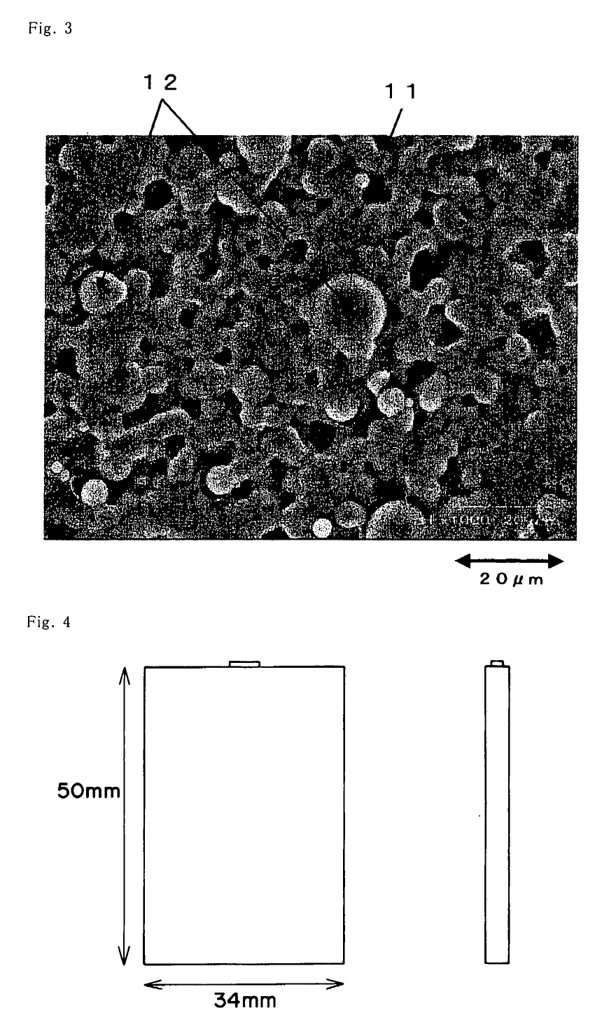

1.3 Grams of a polyethylene powder (FLO-BEADS LE1080 (trade name) manufactured by SUMITOMO SEIKA CHEMICALS Co., Ltd.; average particle size: 6 μm) was added to 100 g of a PVdF solution in NMP (KF POLYMER L #1120 manufactured by KUREHA CORPORATION; PVdF concentration: 12% by weight) while stirring, and the resultant mixture was further stirred for 1 hour to obtain a liquid composition (slurry) for forming a resin layer. This slurry was applied on both the front and back surfaces of the aluminum foil of the positive electrode so as to have a length of 10 mm, measured from the edge of the positive electrode mixture layer, with a die coater (gap: 90 μm), and then NMP was evaporated off to form an insulating resin layer having a thickness of 15 μm. FIG. 3 is an electron micrograph of the surface of the insulating resin layer formed. In FIG. 3, numeral 11 and 12 indicate the PVdF resin and the polyethylene resin, respectively.

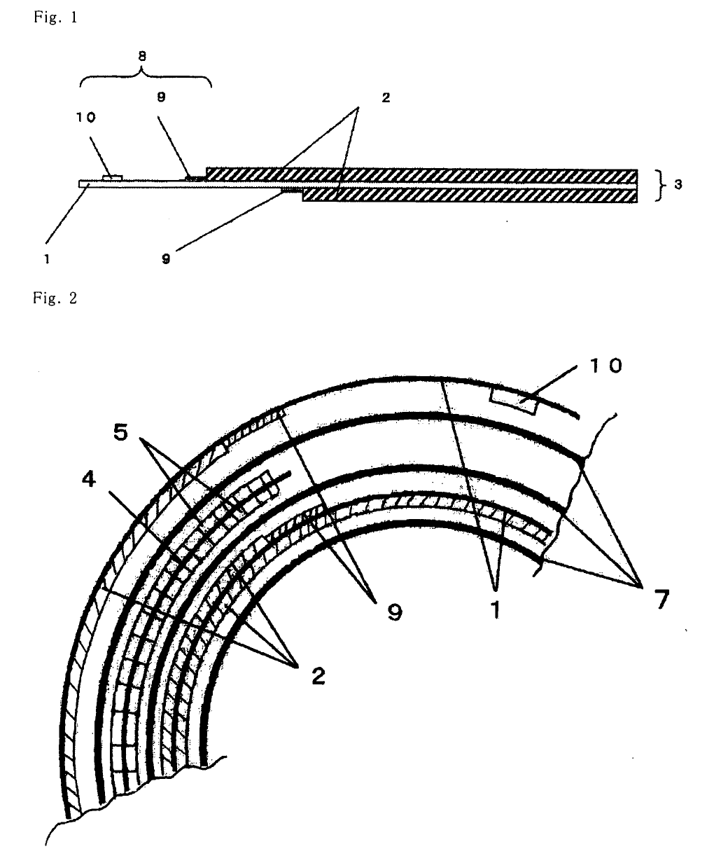

One edge portion of the positive electrode is shown in FIG. 1, in which the positive electrode 3 comprises the positive electrode collector 1 and the positive electrode active material-containing layers 2, and has the exposed portion 10, the insulating resin layers 9 and the tab 10. Numeral 8 indicates the exposed portion.

Production of Negative Electrode

Ninety (90) parts by weight of graphite as a negative electrode active material and 5 parts by weight of PVdF as a binder were uniformly mixed with NMP as a solvent to prepare a paste containing a negative electrode mixture. This paste was applied on both surfaces of an 8 μm thick current collector made from a copper foil, so that the length of the active material applied onto the front surface was 290 mm and the length of the active material applied onto the back surface was 230 mm, and was then dried to form negative electrode mixture layers on the current collector. Thereafter, the negative electrode mixture layers were calendered to adjust the total thickness of the negative electrode mixture layers and the current collector to 140 μm. The current collector having the negative electrode mixture layers formed thereon was cut to form a negative electrode having a length of 300 mm with an exposed portion of the front surface being 10 mm long, and a width of 44 mm. Furthermore, a tab made of nickel was connected to the exposed portion of the copper foil of the negative electrode.

Production of Electrode Body and Battery

A microporous polyolefin film (thickness: 18 μm, porosity: 50%) as a separator was interposed between the positive electrode with insulating resin layer and the negative electrode to form an electrode laminate. Then, the laminate was wound so that the insulating resin layer provided on the exposed portion of the current collector of the positive electrode faced the negative electrode to obtain an electrode body (a power generating unit). FIG. 2 schematically shows the wound electrode body in the vicinity of the periphery thereof, which comprises the positive electrode collector 1, the positive electrode active material-containing layers 2, the negative electrode collector 4, the negative electrode active material-containing layers 5, the separator 7, the insulating resin layers 9, and the tab 10.

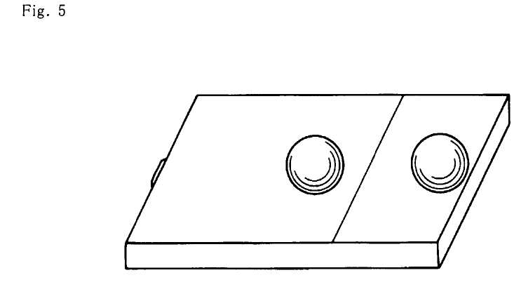

The electrode body was inserted in a battery can made of an aluminum alloy, and an electrolyte (1.0 mol/l of LiPF₆ in a mixed solvent of ethylene carbonate and diethyl carbonate at a volume ratio of 1:2) was poured in the battery can, and then the battery can was sealed to produce a non-aqueous secondary battery. The size and shape of the battery are shown in FIG. 4.

### EXAMPLE 2

A non-aqueous secondary battery was produced in the same manner as in Example 1 except that the polyethylene powder was replaced with a polyethylene powder having an average particle size of 3 μm (FLO-BEADS LE1080 (trade name) manufactured by SUMITOMO SEIKA CHEMICALS Co., Ltd.) and that the thickness of the insulating resin layer was changed to 6 μm.

### EXAMPLE 3

A non-aqueous secondary battery was produced in the same manner as in Example 1 except that the polyethylene powder was replaced with a polypropylene powder (PPW-5 (trade name) manufactured by SEISHIN ENTERPRISE Co., Ltd.; average particle size: 6 μm).

### EXAMPLE 4

A non-aqueous secondary battery was produced in the same manner as in Example 1 except that the polyethylene powder was replaced with a cross-linked polymethyl methacrylate (PMMA) powder (GANZPEARL (trade name) manufactured by GANZ CHEMICAL Co. Ltd.; average particle size of 6 μm).

### COMPARATIVE EXAMPLE 1

A non-aqueous secondary battery was produced in the same manner as in Example 1 except that the end portion of the aluminum foil, to which a tab was not connected, was not cut out, and that no insulating resin layer was provided on the exposed portion of the aluminum foil of the positive electrode.

### COMPARATIVE EXAMPLE 2

A non-aqueous secondary battery was produced in the same manner as in Example 1 except that no insulating resin layer was provided on the exposed portion of the aluminum foil of the positive electrode.

### COMPARATIVE EXAMPLE 3

A non-aqueous secondary battery was produced in the same manner as in Example 1 except that the end portion of the aluminum foil, to which a tab was not connected, was not cut out.

### COMPARATIVE EXAMPLE 4

A non-aqueous secondary battery was produced in the same manner as in Example 1 except that the insulating resin layer was replaced with a polypropylene pressure-sensitive adhesive tape (No. 3703DF (trade name) manufactured by NITTO DENKO CORPORATION; total thickness: 55 μm) attached to the same position.

The non-aqueous secondary batteries of Examples 1 to 4 and Comparative Examples 1 to 4 were evaluated according to the following methods.

Thickness of Battery

After the completion of sealing, the maximum thickness of each non-aqueous electrolyte battery was measured with a slide caliper.

Crushing Test of Battery

Twenty samples were prepared for each of the non-aqueous electrolyte batteries of Examples 1 to 4 and Comparative Examples 1 to 4. An iron ball having a diameter of 15 mm was placed at the middle of the upper surface of each of the ten samples, and was placed on the upper surface of each of another ten samples in a position closer to the bottom of the battery, as shown in FIG. 5. Then, pressure was applied onto the iron ball from above until an about 1.5 mm-deep depression was formed. Then, the number of samples the temperature of which exceeded 100° C. was counted.

The evaluation results are shown in Table 1.

TABLE 1

| | | | | Crushing Test | |
|---|---|---|---|---|---|
| | | | | No. of Samples | |
| | | | | Generating Heat | |
| | | | | | Pressure |
| | | Tab-Nonconnected | | Pressure | Applied |
| | Tab-Connected | End Portion | Battery | Applied on | Closer to |
| Example | End Portion of | of Aluminum | Thickness | Middle of | Bottom of |
| No. | Aluminum Foil | Foil | (mm) | Battery | Battery |
| Ex. 1 | Insulating Resin | Removed | 4.25 | 0/10 | 0/10 |
| | Layer (PE) | | | | |
| | Thickness: 15 μm | | | | |
| Ex. 2 | Insulating Resin | Removed | 4.25 | 0/10 | 0/10 |
| | Layer (PE) | | | | |
| | Thickness: 6 μm | | | | |
| Ex. 3 | Insulating Resin | Removed | 4.25 | 0/10 | 0/10 |
| | Layer (PP) | | | | |
| | Thickness: 15 μm | | | | |
| Ex. 4 | Insulating Resin | Removed | 4.25 | 0/10 | 0/10 |
| | Layer (PMMA) | | | | |
| | Thickness: 15 μm | | | | |
| Comp. | No Insulating | Not Removed | 4.25 | 3/10 | 1/10 |
| Ex. 1 | Resin Layer | | | | |
| Comp. | No Insulating | Removed | 4.25 | 2/10 | 1/10 |
| Ex. 2 | Resin Layer | | | | |
| Comp. | Insulating Resin | Not Removed | 4.25 | 3/10 | 0/10 |
| Ex. 3 | Layer | | | | |
| | Thickness: 15 μm | | | | |
| Comp. | PP Tape | Removed | 4.32 | 0/10 | 0/10 |
| Ex. 4 | Thickness: 30 μm | | | | |

As can be seen from the results shown in Table 1, the non-aqueous electrolyte batteries of Examples 1 to 4, the positive electrode of which had no exposed portion of the current collector at its end to that no positive electrode tab was provided, and which was provided with the insulating resin layer on a part of the aluminum foil facing the negative electrode, had high safety, because a large current did not flow even when the battery was deformed by the high external pressure to cause the internal short circuiting.

Further, the insulating resin layer according to the present invention achieved the same level of safety as the conventional insulating tape although the insulating resin layer was thinner than the insulating tape. This result indicates that the insulating resin layer according to the present invention can contribute to the reduction of the thickness of the battery.

1. A non-aqueous electrolyte battery comprising an wound electrode body which comprises a positive electrode having a layer of a positive electrode active material formed on a current collector, a negative electrode having a layer of a negative electrode active material formed on a current collector and a separator interposed between the positive electrode and the negative electrode, and a non-aqueous electrolyte, wherein the positive electrode has an exposed portion having no layer of the positive electrode active material at least at one of a winding-start edge and a winding-finish edge of the positive electrode so as to provide a lead member which is connected to an external terminal, an insulating layer comprising at least two resins is formed on the exposed portion of the current collector of the positive electrode in a part where the exposed portion of the current collector of the positive electrode faces the exposed portion of the current collector of the negative electrode through the separator, and the winding-start edge or the winding-finish edge of the positive electrode having no lead member has no exposed portion of the current collector.

2. The non-aqueous electrolyte battery according to claim 1, wherein the insulating resin layer provided on the exposed portion of the current collector of the positive electrode faces the exposed portion of the current collector of the negative electrode and the negative electrode active material-containing layer through the separator interposed therebetween.

3. The non-aqueous electrolyte battery according to claim 1, wherein the winding-start edge or the winding-finish edge of the positive electrode having no exposed portion of the current collector at which a lead member is not provided is formed by cutting out an edge part of the positive electrode at a position having the positive electrode active material-containing layer to remove an exposed portion of the current collector of the positive electrode.

4. The non-aqueous electrolyte battery according to claim 1, wherein a part of the insulating resin layer overlaps the positive electrode active material-containing layer.

5. The non-aqueous electrolyte battery according to claim 1, wherein a part of the insulating resin layer is swelled with the electrolyte to have a width larger than that of the positive electrode.

6. The non-aqueous electrolyte battery according to claim 1, wherein a part of the insulating resin layer is interposed between the electrode body and a case of the battery.

7. The non-aqueous electrolyte battery according to claim 1, wherein the insulating resin layer has a thickness of 5 to 30 μm.

8. The non-aqueous electrolyte battery according to claim 1, wherein the insulating resin layer comprises PVdF or a derivative thereof.

9. The non-aqueous electrolyte battery according to claim 1, wherein the insulating resin layer comprises at least one resin selected from the group consisting of polyethylene, polypropylene, an ethylene-propylene copolymer, an ethylene-vinyl acetate copolymer, polymethyl methacrylate, an ethylene-methyl methacrylate copolymer, and derivatives thereof.

10. The non-aqueous electrolyte battery according to claim 9, wherein the resin has a spherical, substantially spherical, cluster, fibrous, rod or crushed shape or a thermally deformed shape thereof.

11. The non-aqueous electrolyte battery according to claim 9, wherein the resin has a particle size of from 0.1 to 50 μm.
